(19) United States
(12) Patent Application Publication
(10) Pub. No.: US 2022/0402684 A1
(43) Pub. Date: Dec. 22, 2022

(54) HANDHELD FOOD ITEM DISPENSER

(71) Applicant: Pawket Treats, Sisters, OR (US)

(72) Inventors: Mark Shenfield, Bend, OR (US); Alec Bryant Velazco, Breckenridge, CO (US)

(21) Appl. No.: 17/807,332

(22) Filed: Jun. 16, 2022

Related U.S. Application Data
(60) Provisional application No. 63/211,500, filed on Jun. 16, 2021.

(51) Int. Cl. B65D 83/04

(52) U.S. Cl. CPC B65D 83/0409

(57) ABSTRACT

A handheld dispenser for retaining disk-shaped food items includes a housing enclosing an interior chamber, a housing back end and an open front end, a tray for receiving disc-shaped food items, the tray slideably insertable in the open front end of the housing and a plunger having a cross-section corresponding to the interior chamber and an angled front face, the plunger slideable with respect to the housing and the tray. A dispenser may also include a housing having a top shell slideably engaged with a bottom shell to form an interior chamber with an open front end and a closed back end. Either housing may include a plunger having a cross-section corresponding to the interior chamber and an angled front face, the plunger slideable with respect to the housing.

### CROSS REFERENCE TO RELATED APPLICATIONS

This application claims the priority benefit of U.S. Provisional Patent Application Ser. No. 63/211,500, filed Jun. 16, 2021. The entirety of this application is hereby incorporated by reference.

### BACKGROUND

Food items, such as snacks or treats, are a popular tool for use with animals to reinforce preferred behaviors. Pet owners may select from a wide variety of biscuits, pellets and other snack forms that are provided in bags or boxes. Both the treats themselves and the packaging are bulky and not convenient for use anywhere other than in the home.

Pets, especially dogs, often accompany their owners to many different locations outside the home including parks as well as stores or even some restaurants. As pet owners participate in more activities with their dogs, there is a growing interest in treats that are portable and convenient to use.

### SUMMARY OF THE EMBODIMENTS

In a first aspect, a handheld dispenser for retaining disk-shaped food items includes a housing having an interior chamber for receiving disc-shaped food items, the housing including a top shell comprising walls forming a portion of the interior chamber, an open front end and a closed back end and a bottom shell comprising a base forming a portion of the interior chamber, and a back wall, the bottom shell slideably insertable in the open front end of the top shell so that the back wall is adjacent to the closed back end; the dispenser also including a plunger having a cross-section corresponding to the interior chamber and an angled front face, the plunger slideable with respect to the housing; a spring retained between the plunger and the back wall of the bottom shell; a first magnet retained in the plunger opposite the front face; a second magnet retained in the back wall; wherein the first and second magnets retain the plunger against the back wall when the back wall of the bottom shell is not adjacent to the back end of the top shell.

### BRIEF DESCRIPTION OF THE FIGURES

FIG. 1 depicts one example handheld food item dispenser, in embodiments.

FIG. 2A is a side view of the dispenser of FIG. 1, in embodiments.

FIG. 2B is a top view of the dispenser of FIG. 1, in embodiments.

FIG. 2C is a cross-sectional view of the dispenser of FIG. 2B, in embodiments.

FIG. 3 is an exploded view of the dispenser of FIG. 1, in embodiments.

FIG. 4 is a side view of a bottom shell of the dispenser of FIG. 1, in embodiments.

FIG. 5A is a perspective outside view of a top shell of the dispenser of FIG. 1, in embodiments.

FIG. 5B is a perspective inside view of a top shell of the dispenser of FIG. 1, in embodiments.

FIG. 5C is a bottom inside view of a top shell of the dispenser of FIG. 1, in embodiments.

FIGS. 6A and 6B are side and perspective views of a plunger of the dispenser of FIG. 1, in embodiments.

FIG. 6C is a perspective of pegs used with the plunger of FIGS. 6A and 6B, in embodiments.

FIGS. 7A-7C show a process of loading the dispenser of FIG. 1, in embodiments.

FIG. 8 shows the dispenser of FIG. 1 with a wrist strap, in embodiments.

FIG. 9 shows the dispenser of FIG. 1 with a carrying device, in embodiments.

FIG. 10 is an exploded view of another example handheld food dispenser, in embodiments.

FIG. 11A is a top view of a housing of the dispenser of FIG. 10, in embodiments.

FIG. 11B is a side view of a housing of the dispenser of FIG. 10, in embodiments.

FIG. 11C is a perspective outside view of an housing of the dispenser of FIG. 10, in embodiments.

FIG. 12 is a perspective view of the dispenser of FIG. 10, in embodiments.

### DETAILED DESCRIPTION OF THE EMBODIMENTS

For purposes of illustration, embodiments herein are discussed with regard to disc-shaped foot items, particularly pet treats. In other embodiments, the disclosed devices and methods may be used with any generally disc-shaped object, such as candy, pills or toys, for example.

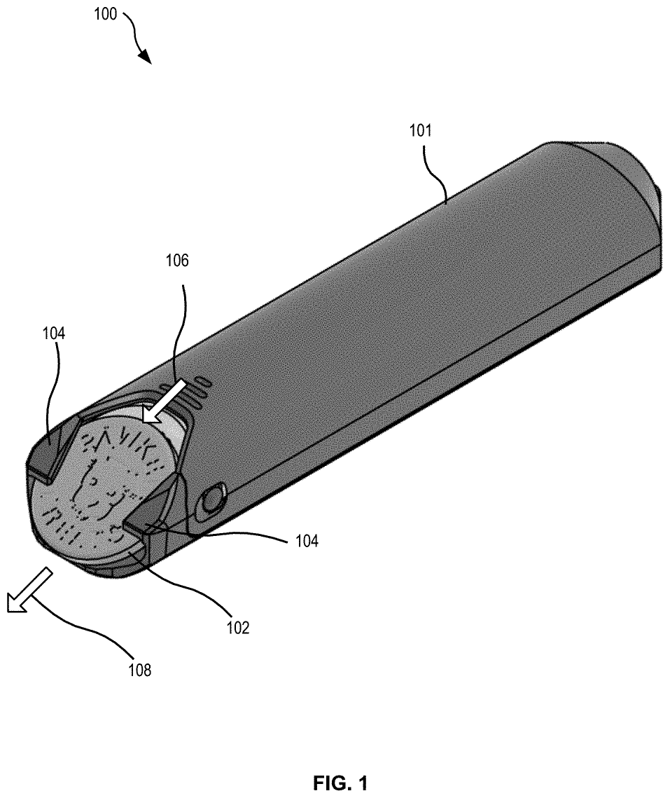

FIG. 1 shows one example handheld dispenser 100, in embodiments. Food items, in the form of disc-shaped pet treats 102 are retained within housing 101 of handheld dispenser 100 by tabs 104. A plunger and spring (not shown) inside housing 101 maintain one or more treats 102 against tabs 104. Treats 102 may be removed by pushing a treat 102 at the front of housing 101 in the direction of arrow 106 so that treat 102 slides down and out of dispenser 100 in the direction of arrow 108.

In an embodiment, treats 102 are cylindrical, disc-shaped treats with a diameter of approximately 25 mm (0.98 inches) which is slightly larger than a quarter (0.955 inches) and a great size for feeding to a dog or other pet. This diameter is slightly larger than the width of an average thumb and may be cleanly licked out of a user's hand without the dog's saliva coming into contact with the user's fingers. It may also easily be broken into smaller pieces for smaller dogs.

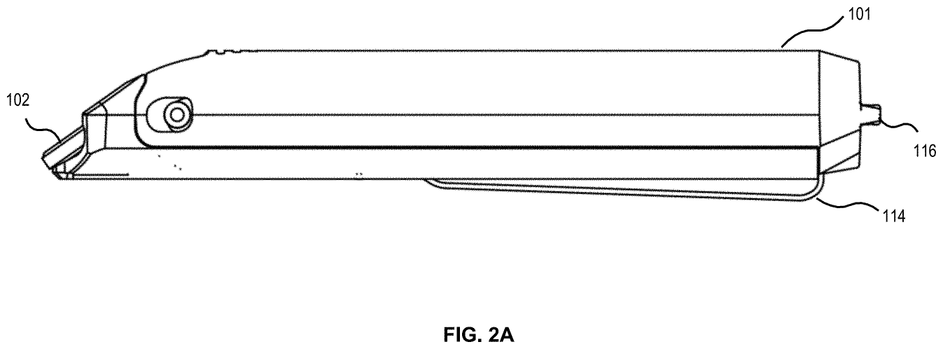

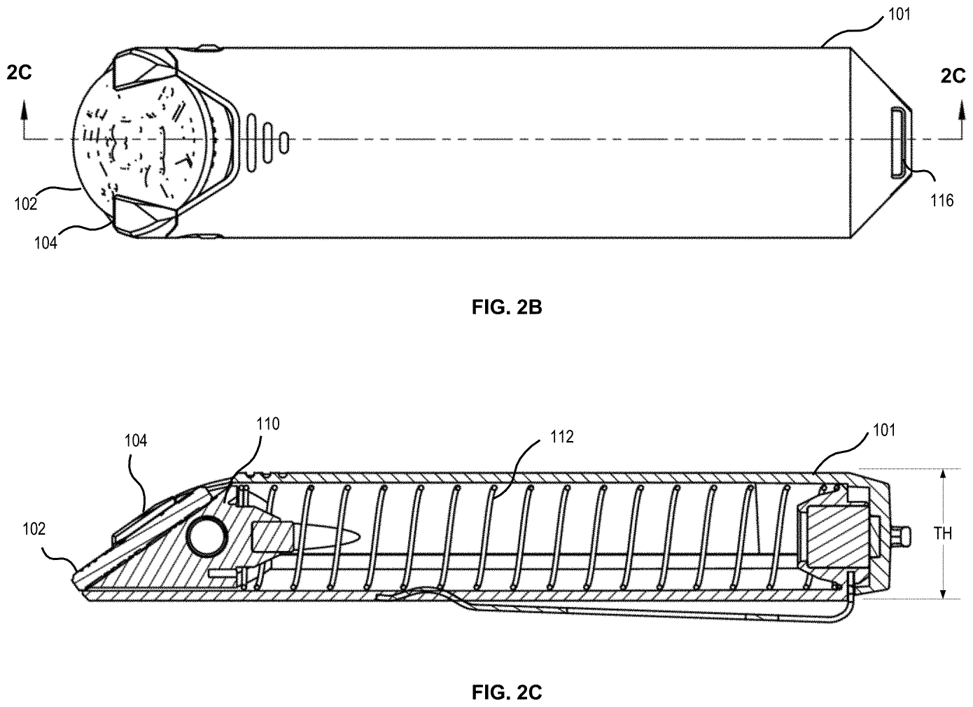

FIG. 2A shows a side view of dispenser 100. FIG. 2B shows a top view and FIG. 2C shows a cross-sectional view along line 2C-2C in FIG. 2B, in embodiments. FIGS. 2A-2C are best viewed together in the following discussion.

To create a slim profile dispenser for a 25 mm diameter treat, treats 102 are angled within housing 101. For example, at a 35° treat angle, the dispenser's overall thickness TH may be under 20 mm creating a thin device that may be conveniently carried in a pocket, purse, bag, etc. without taking up too much space. This is thinner than roll of treats stacked at 90°, or vertically. This angle also creates an ergonomic advantage wherein the user may hold the dispenser in their hand and push treats out with their thumb in a comfortable motion. Although a 35° angle is shown, a variety of angles are contemplated, from approximately 10° to 90°.

Dispenser 100 is designed to hold a quantity of treats 102, for example 15 treats. As shown in FIG. 2C, plunger 110 pushes treat 102 against tabs 104. Spring 112 is positioned between plunger 110 and the back of housing 101 to maintain a force against plunger 110. As shown in FIG. 2C, housing 101 is only holding one treat. If additional treats were placed inside dispenser 100, plunger 110 would be positioned in the middle or back of housing 101, as necessary. As treats 102 are discharged one by one from the front of the dispenser, remaining treats are pushed towards the front by the force of spring 112.

Other features shown in FIGS. 2A-2C will be discussed in more detail below, including clip 114 and strap attachment bracket 116.

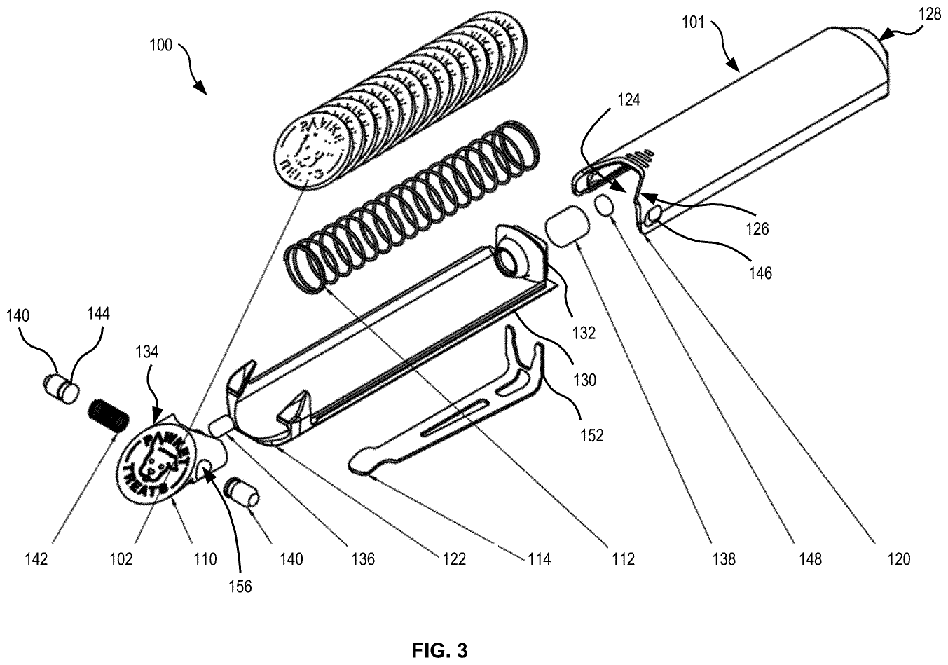

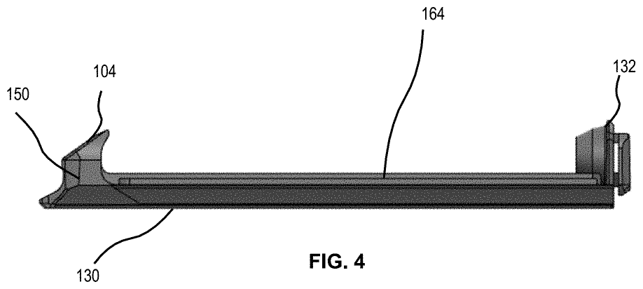

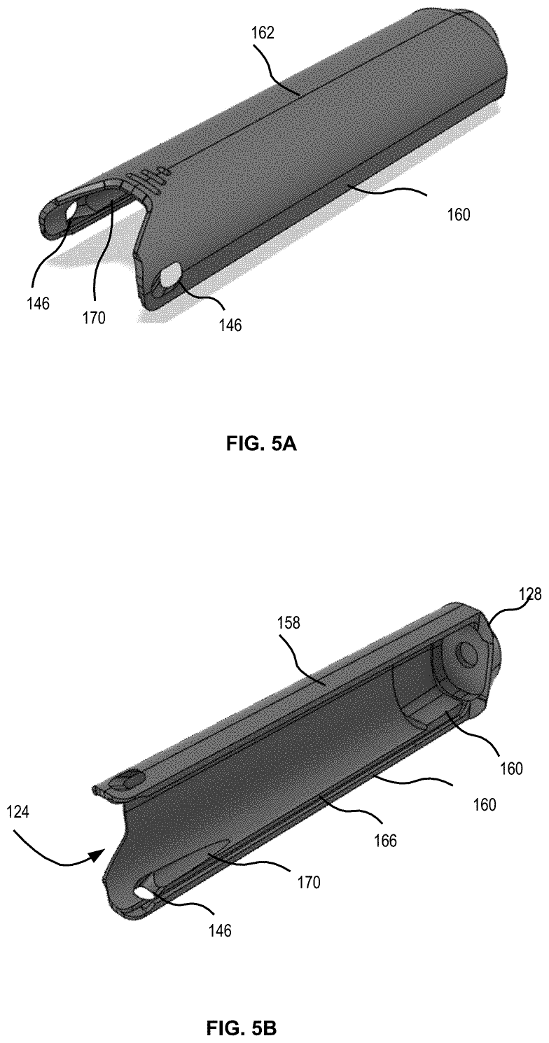

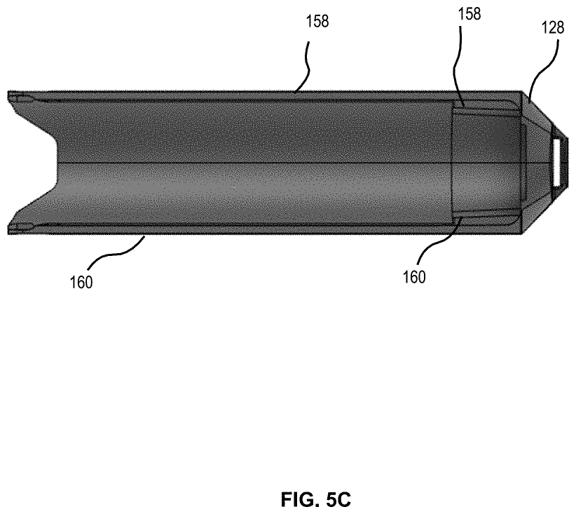

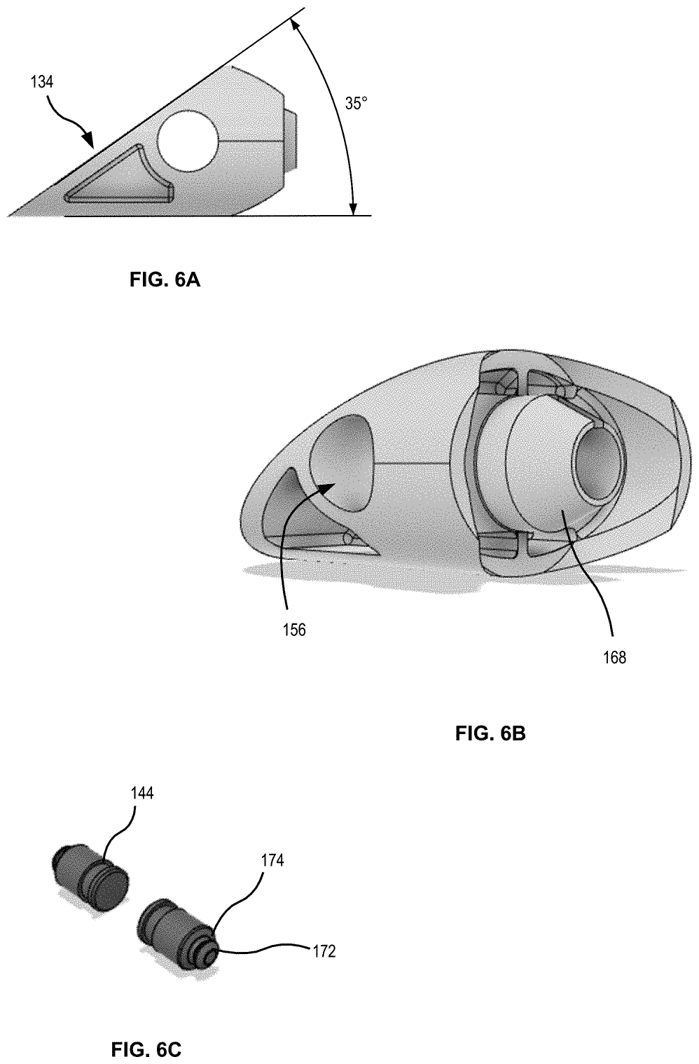

FIG. 3 is an exploded view of dispenser 100 of FIG. 1, in embodiments. FIG. 4 is a side view of bottom shell 122. FIGS. 5A-5C are perspective and bottom inside views of top shell 120. FIGS. 6A and 6B are side and perspective views of plunger 110. FIGS. 3, 4, 5A, 5B, 5C, 6A, 6B and 6C are best viewed together in the following discussion.

Housing 101 is generally in the shape of a flattened tube with an oval cross-section. It includes a top shell 120 and a bottom shell 122 that form an interior chamber 124 for containing treats 102. Top shell 120 includes walls that that generally form three sides of interior chamber 124. Top shell includes open end 126 and closed end 128. Bottom shell 122 include a base 130 and a back wall 132. Base 130 of bottom shell 122 slides into top shell 120 to form interior chamber 124.

Top shell 120 includes two side walls 158 and 160 that are generally perpendicular to bottom shell 122. Side walls 158 and 160 are connected by a curved top wall 162. In embodiments, a square dovetail joint may be used to secure bottom shell 122 to top shell 120. In embodiments, base 130 is slightly curved to correspond to the curvature of treats 102. On each edge of base 130, tail 164 is formed along the length of base 130. Corresponding sockets 166 are formed along the inside of side walls 158 and 160. Although other joint designs may be used to provide a sliding connection between bottom shell 122 and top shell 12, a square dovetail track provides the benefit of good manufacturability when using a metal diecast production process. For example, a dovetail design such as an overlapping “z” shape creates a large undercut in the mold that requires more post-processing with a custom fly cutter and thus increased the overall product cost. A square dovetail design also creates a smaller overall dovetail and allows the walls of base 130 to be larger, creating more of a tray for treats 102 when loading them into dispenser 100.

Plunger 110 is generally oval-shaped with a cross-section corresponding to interior chamber 124. In other words, the outside diameter profile of plunger 110 is provided to fit within interior chamber 124 so that it fits securely while still sliding freely. Plunger 110 has an angled front face 134. In embodiments, this angle is approximately 35° which helps maintain treats 102 at a preferred orientation as they are pushed from the back to the front of the dispenser. As explained above, a variety of angle could be used. Spring 112 is positioned between plunger 110 and back wall 132 of bottom shell 122.

Magnet 136 is centered in the back of plunger 110 in cone-shaped fitting 168. In embodiments, magnet 136 has north and south poles in the same orientation as the direction of the spring. This magnet is designed to lock to magnet 136 installed in back wall 132 as described in more detail below.

Perpendicular to and just in front of magnet 136, a cylindrical cavity 156 that contains two cylindrical pegs 140 with a spring 142 of similar diameter in-between them. Pegs have locking groove 144 that spring 142 clips onto so that spring 142 gently pushes the pegs against the inside of the dispenser walls with minimal force.

As treats 102 are removed from dispenser 100 and plunger 110 is pushed from the back of the dispenser to the front via the spring 112, pegs 140 glide along the inside of top shell 120 creating little friction, but with enough force that eventually the head of pegs 140 push into a tapered track 170 which guides them into angled slots 146 at the front of side walls 158 and 160 in top shell 120. Angled slots 146 form an elongated opening between the interior chamber of the housing and an exterior of the housing.

To load treats 102 into housing 101, interior chamber 124 is accessed by sliding top shell 120 and bottom shell 122 relative to each other. Since treats 102 are loaded in front of housing 101, plunger 110 also needs to be pulled back as top shell 120 and bottom shell 122 slide apart.

While sliding housing 101 open, spring-loaded pegs 140 that sit inside of plunger 110 and lightly push against the interior sidewall of top shell 120. The force of spring 142 is selected to allow plunger 110 to slide through housing 101 with little resistance. When plunger 110 is at the front of housing 101, and as the last treat is discharged, the pegs push into angled slots 146 on either side of the top shell. Angled slots 146 are angled through the thickness of side walls 158 and 160, as shown in FIGS. 5A and 5B so that the opening of angled slot 146 on the outside of top shell 120 is slightly offset from the opening on the inside.

The shape of pegs 140 is symmetrical and designed such that there is a “neck” and “head” on the side opposite the spring. The head is the same length as the wall thickness of top shell 120, has a smaller diameter than the peg body, and is chamfered on the outer edge 172. The smaller diameter head allows the peg head to push through the angled slot at a controlled distance since the peg shoulders cannot push through the angled slot. Chamfered outer edge 172 on the peg's heads allows them to easily slide in the shell and also enables the top shell to “recess” the pegs into the plunger and slide past it when closing the shells during the reloading process as described in more detail below. The neck of the peg creates an area 174 for the angled slot in the top shell to go into and “grab” the pegs to pull the spring-loaded plunger back when opening the shells to reload the dispenser.

The angled slot in the top shell has a tapered track 170 behind it on the inside surface of top shell 120 to make sure the pegs 140 expand fully into angled slot 146. In embodiments, spring 112 has a greater spring rate than the spring rate of spring 142. Without the tapered track or a larger hole in the side of the dispenser, pegs 140 would fly past the angled slot if dispenser 100 is closed with no treats in it, resulting in a disassembled dispenser.

In embodiments, a magnetic locking mechanism holds plunger 110 against back wall 132 during the loading process. Magnet 136 is retained in a cone-shaped fitting that protrudes from plunger 110 into the front end of spring 112. Magnet 138 is positioned in back wall 132 and cone-shaped fitting which protrudes into the back end of spring 112.

When a user slides the shells apart, top shell 120 pulls plunger 110 back which recesses the spring 112 to its solid height, at which point magnet 136 and magnet 138 engage inside of spring 112. By engaging inside of spring 112, more space is available in the interior chamber 124 so that the overall length of dispenser 100 may be as small as possible. In embodiments, magnets 136 and 138 are selected to have a magnetic attraction force that is just stronger than the force of spring 112 when compressed to its solid height, thus keeping the spring recessed and plunger held to the back of the dispenser.

Once the user drops in a stack of treats 102 to refill the dispenser, they will then close top shell 120 by sliding it forward which recesses pegs 140 out of angled slots 146. The shell will freely move over the treats while spring 112 continues to be recessed.

Once the top shell is about to reach its closed position, two fixed pushing blocks (not shown) on the back sides of top shell 120 engage with the back sidewalls of the plunger and separate the magnets slightly, at which point the force of the spring surpasses the force of the magnets and allows the plunger to push forward against the treats. Retaining plunger 110 at the back of bottom shell 122 until housing 101 is almost closed prevents force from spring 112 from ejecting treats out of dispenser 100 before it is closed.

Magnet 148 is positioned in closed end 128 of top shell 120. Magnet 148 cooperates with magnet 138 to retain bottom shell 122 in place against top shell 120 during use of dispenser 100.

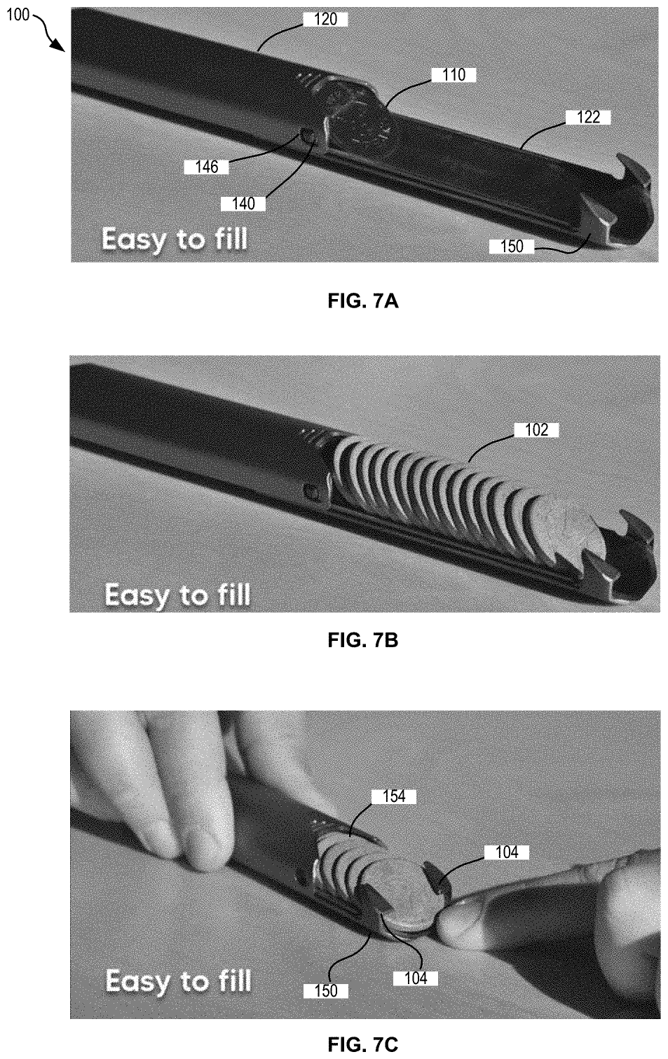

FIGS. 7A-7C illustrate a process of loading dispenser 100 with treats 102. In embodiments, a stack of treats, for example 15 treats, may be loaded at a time. This loading process saves time for the user as opposed to a process where treats have to be loaded one at a time.

This is accomplished by providing housing 101 with top shell 120 and bottom shell 122 that are connected via a dovetail track. Bottom shell 122 acts like a tray for treats 102 during the loading process, and top shell 120 acts as a cover for treats 102 during the shell closing process before plunger 110 is released.

As shown in FIG. 7A, a user opens housing 101 by sliding top shell 120 and bottom shell 122 apart. Angled slots 146 engage with pegs 140 to pull plunger 110 back with top shell 120. This leaves a space in bottom shell 122 where a stack of approximately 15 treats may be placed onto bottom shell 122. Angled face 134 of plunger 110 causes treats 102 to lay over at an angle, for example 35°, as shown in FIG. 7B. Once loaded, the user may close top shell 120 as shown in FIG. 7C. At the front end of bottom shell 122, prongs 150 extend upward from base 130 and culminate in angled tabs 104, which have an angle matching that of plunger 110. Angled tabs 104 retain treats 102 inside dispenser 100 until they are removed.

Between tabs 104 is a gap that's about as large as a thumb, and on the top shell there is a cutaway section 154 that exposes the top edge of one treat. This cutaway section allows the user to push one treat out of the dispenser at a time with their thumb

In embodiments, dispenser 100 does not use attachment devices such as screws or require any tools to assemble or disassemble. This provides ease of use in cleaning or replacing a part.

In embodiments, dispenser 100 may include other elements that increase portability and convenience for a user.

Clip 114 is provided to allow a user to carry dispenser 100 on a pocket, belt or other preferred location. For flexibility, clip 114 is not permanently attached to dispenser 100, and may be added by a user without attachment devices or tools. Clip 114 snaps into and off of the dispenser using a device similar to “e” or “c” style retaining rings, we designed the back “snap point” of the clip to flex around a cylinder. To hold the clip in place and create the preload needed to give the clip 114 its desired tension, clip 114 includes a bracket 152 that slides into a slot in back wall 132 of bottom shell 122 which holds clip 114 at a fixed orientation and puts a preload on the clip against the bottom of the bottom shell.

In embodiments, clip 114 stainless sheet metal, and housing 101 is aluminum. Clip 114 snaps around the magnet 138 to prevent the clip from eating into the aluminum shells over a period of time.

In embodiments, dispenser 100 may be used with a wrist strap 180 that may be attached to attachment bracket 116 on the closed end of top shell 120 as shown in FIG. 8. Wrist strap 180 provides another option for users to carry dispenser 100.

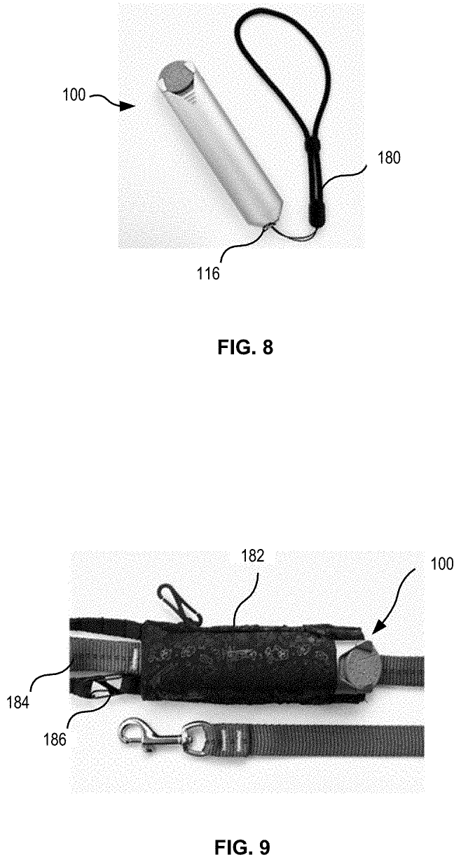

In a further embodiment, dispenser 100 may be used with a leash attachment sleeve 182 as shown in FIG. 9. For users who do not like carrying items in their pocket when walking their dog(s), or who do not have pockets, and who don't like “hip clip” type items, leash attachment sleeve 182 is a fabric sleeve that attaches around a dog leash 184.

Leash attachment sleeve 182 includes an opening (not shown) for the leash to pass through so the sleeve hugs the leash, instead of dangling from it. In embodiments, on one side of the leash, parallel with the leash, the dispenser slides into a “pocket” that has a flap on one end that corresponds to the open end of the dispenser. The flap may be pulled open with a tab, and the user may dispense a treat. In embodiments, leash attachment sleeve 182 may also include, on the other side of the leash, also parallel with the leash, a hidden pocket for cash, keys, a bag, etc. In some embodiments, at the top of the leash attachment sleeve 182, closest to the leash handle, there's a small strap 186 or other attachment mechanism that loops into the leash handle to keep the leash sleeve and dispenser near the user's hand for ease of use.

In embodiments dispenser 100 may be made of a variety of materials, including aluminum and plastic, for example. Manufacturing techniques appropriate to the material may be used, including machining, molding and extruding and sonic welding. Different materials may be combined in one dispenser. Parts may also be designed to snap together with tabs and slots, for example.

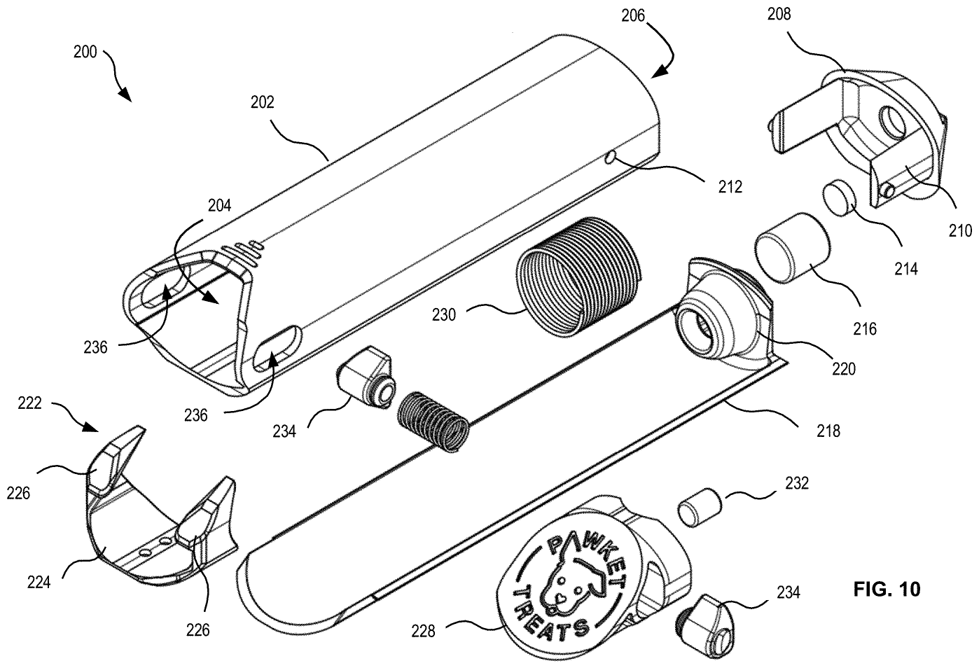

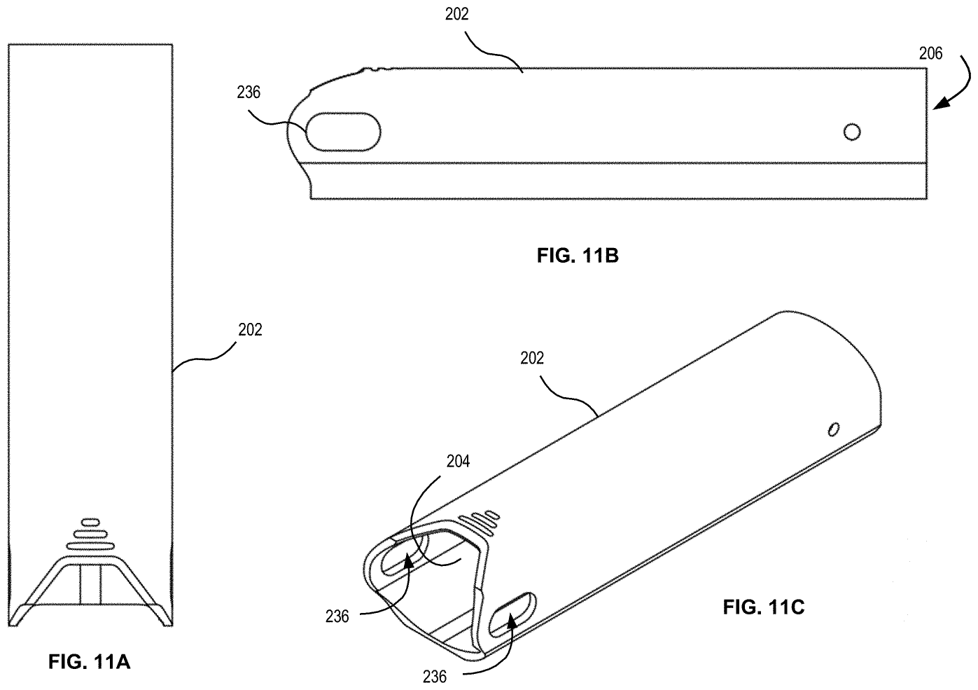

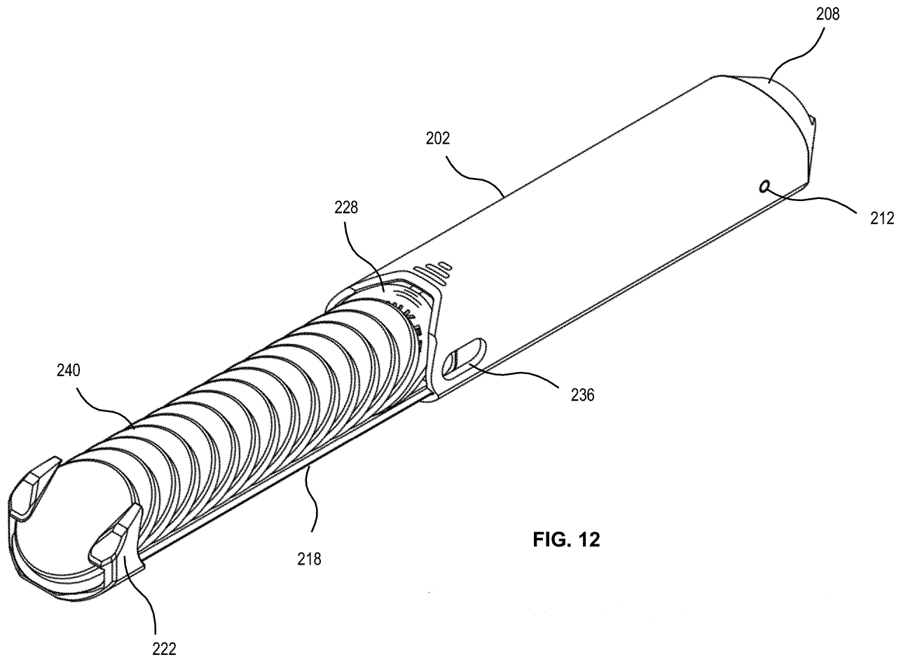

FIG. 10 is an exploded view of another example handheld food dispenser 200. FIGS. 11A-11C are top, side and perspective views of top shell 120. FIG. 12 is a perspective view of dispenser 200. FIGS. 10, 11A, 11B, 11C and 12 are best viewed together in the following discussion.

Dispenser 200 functions similarly to dispenser 100 with regard to the mechanism for opening and closing the dispenser and loading treats 240. As shown in FIG. 10, housing 202 is a generally cylindrical tube with an interior chamber 204 and a housing back end 206. Back cap 208 includes tabs 210 which slide into housing back end 206 and engage with holes 212. Magnets 214 and 216 are an examples of magnets 148 and 138, respectively, of dispenser 100 and function in a similar way.

Tray 218 is similar to bottom shell 122 of dispenser 100, however, it is designed to slide into interior chamber 204 and be fully enclosed within it. Tray 218 includes a tray back wall 220 that is similar to back wall 132 of bottom shell 122. In addition, tray 218 may have a slight curvature to better retain pet treats 240. Prong assembly 222 includes a prong assembly base 224 with prong assembly tabs 226 extending upward from prong assembly base 224. Prong assembly 222 is an example of tabs 104 and prongs 150 of dispenser 100. Prong assembly 222 may be manufactured as one piece with tray 218, or as a separate piece that is subsequently secured to tray 218. Housing 202 may include internal slots or grooves for retaining tray 218 so that is slides smoothly into and out of housing 202.

Dispenser 200 is designed to hold a quantity of treats 240, for example 15 treats. As shown in FIG. 10, plunger 228 is an example of plunger 110 of dispenser 100. Spring 230 is an example of spring 112 and is positioned between plunger 228 and tray back wall 220 to maintain a force against plunger 228. As treats 240 are discharged one by one from the front of the dispenser, remaining treats are pushed towards the front by the force of spring 230. Plunger 228 includes a magnet 232 and spring loaded pins 234 that engage with angled slots 236 in housing 202 as described above for dispenser 100.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A handheld food item dispensing apparatus, comprising:
a housing enclosing an interior chamber, a housing back end and an open front end;
a tray for receiving disc-shaped food items, the tray slideably insertable in the open front end of the housing;
a plunger having a cross-section corresponding to the interior chamber and an angled front face, the plunger slideable with respect to the housing and the tray.

2. The apparatus of claim 1, further comprising:
a spring retained between the plunger and a tray back wall;
a first magnet retained in the plunger opposite the angled front face; and
a second magnet retained in the tray back wall;
wherein the first and second magnets retain the plunger against the tray back wall when the tray back wall is not adjacent to the housing back end.

3. The apparatus of claim 2, wherein the housing back end further comprises a third magnet for engaging with the first magnet in tray back wall to retain the tray within the housing.

4. The apparatus of claim 1, wherein the plunger further comprises spring-loaded pegs on either side of the plunger that engage with slots adjacent to a front end of the housing to retain the plunger in the housing.

5. The apparatus of claim 4, wherein the slots form an elongated opening between the interior chamber of the housing and an exterior of the housing.

6. The apparatus of claim 1, wherein the tray further comprises:
a prong assembly comprising prongs extending upward from either side of a prong assembly base; and
angled tabs on respective ends of the prongs such that an angle of the angled tab matches the angled front face of the plunger for retaining food items against the angled front face.

7. The apparatus of claim 6, wherein the housing comprises a cutaway section adjacent to the prongs on the prong assembly.

8. The apparatus of claim 1, further comprising an attachment point on an outside of the housing back end for attaching a strap.

9. A handheld food item dispensing apparatus, comprising:
a housing enclosing an interior chamber for receiving disc-shaped food items, said housing comprising:
a top shell comprising walls forming a portion of the interior chamber, an open front end and a closed back end;
a bottom shell comprising a base forming a portion of the interior chamber, and a back wall, the bottom shell slideably insertable in the open front end of the top shell so that the back wall is adjacent to the closed back end;
a plunger having a cross-section corresponding to the interior chamber and an angled front face, the plunger slideable with respect to the housing;
a spring retained between the plunger and the back wall of the bottom shell;
a first magnet retained in the plunger opposite the angled front face; and
a second magnet retained in the back wall;
wherein the first and second magnets retain the plunger against the back wall when the back wall of the bottom shell is not adjacent to the closed back end of the top shell.

10. The apparatus of claim 9, wherein the top shell further comprises, adjacent to the closed back end, pushing blocks to separate the first and second magnets.

11. The apparatus of claim 9, wherein the interior chamber has an oval cross-section and a circumference of the interior chamber is smaller than the circumference of the disc-shaped food items.

12. The apparatus of claim 9, wherein the closed back wall of the top shell further comprises a third magnet for engaging with the first magnet in back wall to retain the bottom shell within the housing.

13. The apparatus of claim 9, wherein the plunger further comprises spring-loaded pegs on either side of the plunger that engage with slots adjacent to the open front end of the top shell to retain the plunger in the housing.

14. The apparatus of claim 13, wherein the slots form an elongated opening between the interior chamber of the housing and an exterior of the housing.

15. The apparatus of claim 14, wherein the top shell further comprises an interior tapered track adjacent to the elongated opening and extending towards the closed back end of the top shell.

16. The apparatus of claim 14, wherein the spring-loaded pegs comprise a peg body having a first diameter and a peg head having a height corresponding to a thickness of the walls of the top shell, and a second diameter smaller than the first diameter, wherein the peg head further comprises a chamfered edge.

17. The apparatus of claim 9, wherein the bottom shell further comprises:
prongs extending upward from either side of the base; and
angled tabs on respective ends of the prongs such that an angle of the angled tab matches the angled front face of the plunger for retaining food items against the angled front face.

18. The apparatus of claim 17, wherein the top shell comprises a cutaway section adjacent to the prongs on the bottom shell.
